(19) United States
(12) Patent Application Publication
(10) Pub. No.: US 2026/0119364 A1
(43) Pub. Date: Apr. 30, 2026

(54) SYSTEMS AND METHODS FOR AUTOMATICALLY IDENTIFYING OPTIMAL VIRTUAL MACHINE COMPONENT PARAMETERS

(71) Applicant: BANK OF AMERICA CORPORATION, CHARLOTTE, NC (US)

(72) Inventors: Mark Edward Fowler, Allen, TX (US); Ramesh Babu Chandanala, Concord, NC (US); Jose Iturria, Astoria, NY (US); Arjun Thimmareddy, Charlotte, NC (US); Basantkumar Tiwari, Edison, NJ (US); Amit Beniwal, Jacksonville, FL (US); John H. Kling, Alexandria, VA (US)

(73) Assignee: BANK OF AMERICA CORPORATION, CHARLOTTE, NC (US)

(21) Appl. No.: 18/933,682

(22) Filed: Oct. 31, 2024

(51) Int. Cl. G06F 11/34; G06F 9/50

(52) U.S. Cl. CPC G06F 11/3452; G06F 9/5077; G06F 11/3495

(57) ABSTRACT

Systems, computer program products, and methods are described herein for automatically identifying optimal virtual machine component parameters. The present disclosure is configured to identify a virtual machine requirement(s); access, by an artificial intelligence (AI) engine, a computing resource database, wherein the computing resource database comprises a plurality of potential computing resources available to meet the virtual machine requirement(s); determine, by the AI engine, a plurality of potential computing resource configurations, wherein each of the plurality of potential computing resource configurations meet the virtual machine requirement(s); determine, by the AI engine, a performance indicator for each potential computing resource configuration; compare the performance indicator for each potential computing resource configuration; and determine an optimized computing resource configuration based on the comparison of each performance indicator.

### FIELD OF THE INVENTION

The present invention embraces a system for automatically identifying optimal virtual machine component parameters.

### BACKGROUND

In today's electronic environments, virtual machines are becoming more and more common to handle different computing functions, including but not limited to running programs and applications, running and testing operating systems, storing data, and connecting networks. One of the many reasons that these virtual machines are used over traditional systems is due to their ability to run different virtual environments from a single machine, which reduces physical infrastructure footprints and allows for easy buildability of these virtual machines for different, specified purposes. However, with these virtual machines, there remains the prevalent issue of building out these virtual machines in an optimized manner and with little to no build time or downtime when computing resources are at capacity and are being shared within one physical environment. Thus, technical issues arise in determining optimal virtual machine component parameters and configurations in an efficient, accurate, and dynamic manner.

Applicant has identified a number of deficiencies and problems associated with determining optimal virtual machine component parameters and configurations. Through applied effort, ingenuity, and innovation, many of these identified problems have been solved by developing solutions that are included in embodiments of the present disclosure, many examples of which are described in detail herein.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for automatically identifying optimal virtual machine component parameters is provided. In some embodiments, the system may comprise: a memory device with computer-readable program code stored thereon; at least one processing device operatively coupled to the at least one memory device and the at least one communication device, wherein executing the computer-readable code is configured to cause the at least one processing device to: identify at least one virtual machine requirement; access, by an artificial intelligence (AI) engine, a computing resource database, wherein the computing resource database comprises a plurality of potential computing resources available to meet the at least one virtual machine requirement; determine, by the AI engine, a plurality of potential computing resource configurations, wherein each of the plurality of potential computing resource configurations meet the at least one virtual machine requirement; determine, by the AI engine, a performance indicator for each of the plurality of potential computing resource configurations; compare the performance indicator for each of the plurality of potential computing resource configurations; and determine an optimized computing resource configuration based on the comparison of the performance indicator for each of the plurality of potential computing resource configurations.

In some embodiments, the at least one virtual machine requirement comprises a plurality of virtual machine requirements across a cluster of a plurality of virtual machines or a cluster of a plurality of virtual machine components. In some embodiments, executing the computer-readable code is further configured to cause the at least one processing device to: identify at least one peak performance requirement and at least one low performance requirement for each virtual machine in the cluster of the plurality of virtual machines or for each virtual machine component in the cluster of the plurality of virtual machine components; determine the optimized computing resource configuration for the cluster of the plurality of virtual machines or for the cluster of the plurality of virtual machine components; and automatically reconfigure the optimized computing resource configuration between each virtual machine in the cluster of the plurality of virtual machines or between each virtual machine component in the cluster of the plurality of virtual machine components based on the identified peak performance requirement or the low performance requirement.

In some embodiments, the plurality of potential computing resource configurations comprises a plurality of different configurations of central processing unit (CPU) parameters, memory parameters, disk parameters, storage parameters, and network interface parameters.

In some embodiments, executing the computer-readable code is further configured to cause the at least one processing device to: identify historical computing resource configurations for a plurality of historical virtual machines; generate a first training dataset comprising the historical computing resource configurations; apply the first training dataset to the AI engine in a first instance; train, based on the application of the first training dataset, the AI engine; identify historical performance indicators for the plurality of historical virtual machines; generate a second training dataset comprising the historical performance indicators; apply the second training dataset to the AI engine at a second instance; and train, based on the application of the second training dataset, the AI engine. In some embodiments, executing the computer-readable code is further configured to cause the at least one processing device to: identify historical peak performance requirements and low performance requirements for the plurality of historical virtual machines; generate a third training dataset comprising the peak performance requirements and the low performance requirements; apply the third training dataset to the AI engine in a third instance; and train, based on the application of the third training dataset, the AI engine.

In some embodiments, the performance indicator for each of the plurality of potential computing resource configurations is associated with a gradient descent.

In some embodiments, the performance indicator for each of the plurality of potential computing resource configurations comprises a cost indicator for employing each potential computing resource configuration.

In some embodiments, the virtual machine requirement comprises a cost constraint, and wherein the cost constraint is used by the AI engine to determine the plurality of potential computing resource configurations.

In some embodiments, the performance indicator is based on a processing speed of each potential computing resource configuration, a lowest parameter combination of computing resources, or a new resource utilization combination.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIGS. 1A-1C illustrates technical components of an exemplary distributed computing environment for automatically identifying optimal virtual machine component parameters, in accordance with an embodiment of the disclosure;

FIG. 2 illustrates an exemplary artificial intelligence (AI) engine subsystem architecture, in accordance with an embodiment of the disclosure;

FIG. 3 illustrates a process flow for automatically identifying optimal virtual machine component parameters, in accordance with an embodiment of the disclosure;

FIG. 4 illustrates a process flow for automatically reconfiguring the optimized computing resource configuration within a cluster of virtual machines and/or cluster of virtual machine components based on performance requirements, in accordance with an embodiment of the disclosure;

FIG. 5 illustrates a process flow for training the AI engine in a first and second instance, in accordance with an embodiment of the disclosure; and

FIG. 6 illustrates a process flow for training the AI engine in a third instance, in accordance with an embodiment of the disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, infrastructure elements (hardware and/or software), devices, services, and the like, and/or the ability and opportunity to access and use the same. Some example implementations herein contemplate central processing units (CPUs), memory, storage, disks, and/or the like.

In today's electronic environments, virtual machines are becoming more and more common to handle different computing functions, including but not limited to running programs and applications, running and testing operating systems, storing data, and connecting networks. One of the many reasons that these virtual machines are used over traditional systems is due to their ability to run different virtual environments from a single machine, which reduces physical infrastructure footprints and allows for easy buildability of these virtual machines for different, specified purposes. However, with these virtual machines, there remains the prevalent issue of building out these virtual machines in an optimized manner and with little to no build time or downtime when computing resources are at capacity and are being shared within one physical environment. Thus, technical issues arise in determining optimal virtual machine component parameters and configurations in an efficient, accurate, and dynamic manner.

The disclosure provides a system, a computer program product, and a computer implemented method configured to identify at least one virtual machine requirement; access, by an artificial intelligence (AI) engine, a computing resource database, wherein the computing resource database comprises a plurality of potential computing resources available to meet the at least one virtual machine requirement; determine, by the AI engine, a plurality of potential computing resource configurations, wherein each of the plurality of potential computing resource configurations meet the at least one virtual machine requirement; determine, by the AI engine, a performance indicator for each of the plurality of potential computing resource configurations; compare the performance indicator for each of the plurality of potential computing resource configurations; and determine an optimized computing resource configuration based on the comparison of the performance indicator for each of the plurality of potential computing resource configurations.

In other words, the disclosure provides a system for iteratively determining optimal configurations for virtual machines, whereby the configurations of the virtual machines may comprise configurations of different central processing unit (CPU) software parameters, memory parameters, disk resources, memory resources, storage resources, network interface parameters, and/or the like, for each configuration of the virtual machine. Based on each configuration of components, the system may determine the most optimal configuration to carry out the intended functions within the virtual machine(s). In some embodiments, the system may comprise an AI engine which is trained with historical data regarding peaks and lows for historically optimized virtual machines, and the AI engine may perform an iterative analysis of each combination of components until it determines the most optimal configuration. In some embodiments, the most optimal configuration may comprise the most cost-effective configuration, best performing configuration (e.g., fastest processing speed, most efficient use of resources), least number of resource(s) used, least number of new resources used, and/or the like.

What is more, the present invention provides a technical solution to a technical problem. As described herein, the technical problem includes the determination of optimal virtual machine component parameters and configurations to carry out the intended purpose of the virtual machine. The technical solution presented herein allows for the efficient, accurate, and dynamic identification of optimal virtual machine component parameters (e.g., virtual machine computing resource configurations). In particular, the disclosure provided herein is an improvement over existing solutions to the determination of optimal virtual machine component configurations, (i) with fewer steps to achieve the solution, thus reducing the amount of computing resources, such as processing resources, storage resources, network resources, and/or the like, that are being used (e.g., by using an AI engine to determine potential computing resource configurations and, from those potential computing resource configurations, the optimal computing resource configuration); (ii) providing a more accurate solution to problem, thus reducing the number of resources required to remedy any errors made due to a less accurate solution (e.g., by determining the optimized computing resource configuration from all the possible computing resource configurations, the system can be sure that the current optimized computing resource configuration was chosen); (iii) removing manual input and waste from the implementation of the solution, thus improving speed and efficiency of the process and conserving computing resources (e.g., by automatically collecting historical computing resource configuration data and automatically collecting performance indicators, the system can improve manual input and waste); (iv) determining an optimal amount of resources that need to be used to implement the solution, thus reducing network traffic and load on existing computing resources (e.g., by determining which virtual machines and/or virtual machine component can share their computing resources in an automatic and dynamic way, the system can determine which computing resources need to be shared to take the burden off overburdened computing resources). Furthermore, the technical solution described herein uses a rigorous, computerized process to perform specific tasks and/or activities that were not previously performed. In specific implementations, the technical solution bypasses a series of steps previously implemented, thus further conserving computing resources.

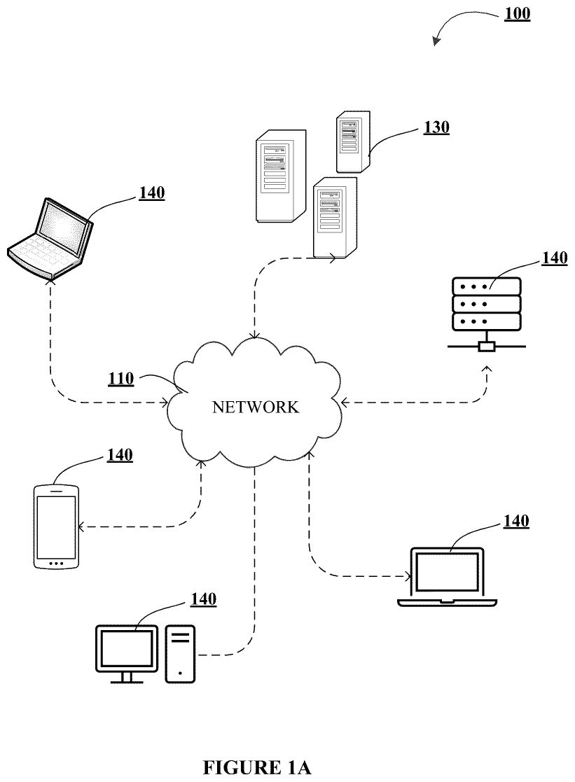

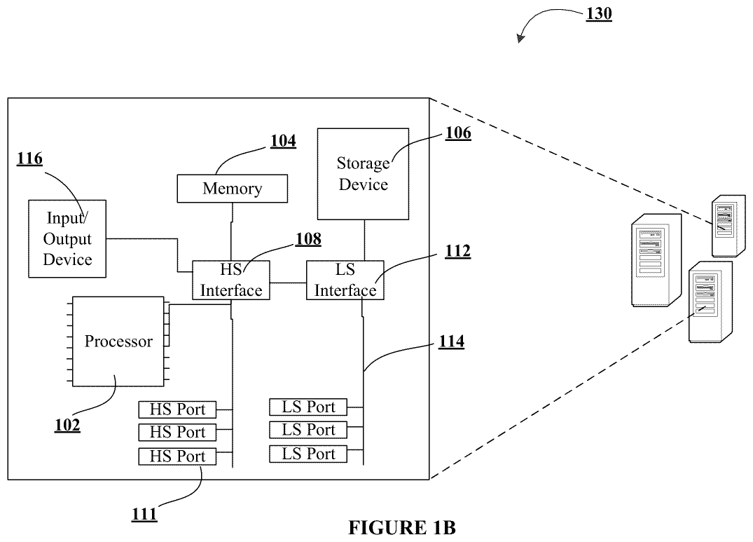

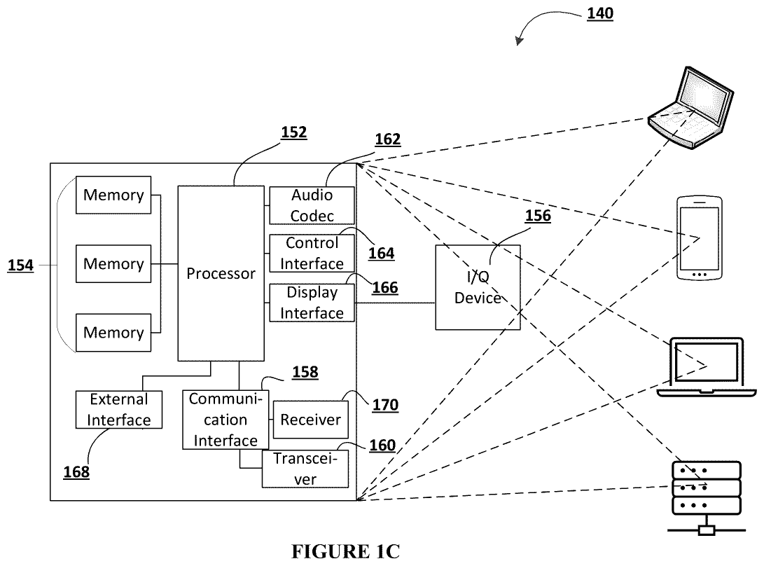

FIGS. 1A-1C illustrate technical components of an exemplary distributed computing environment for automatically identifying optimal virtual machine component parameters 100, in accordance with an embodiment of the invention. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 (shown as “LS Interface”) connecting to low speed bus 114 (shown as “LS Port”) and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 (shown as “HS Interface”) is coupled to memory 104, input/output (I/O) device 116 (e.g., through a graphics processor or accelerator), and to high-speed expansion ports 111 (shown as “HS Port”), which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

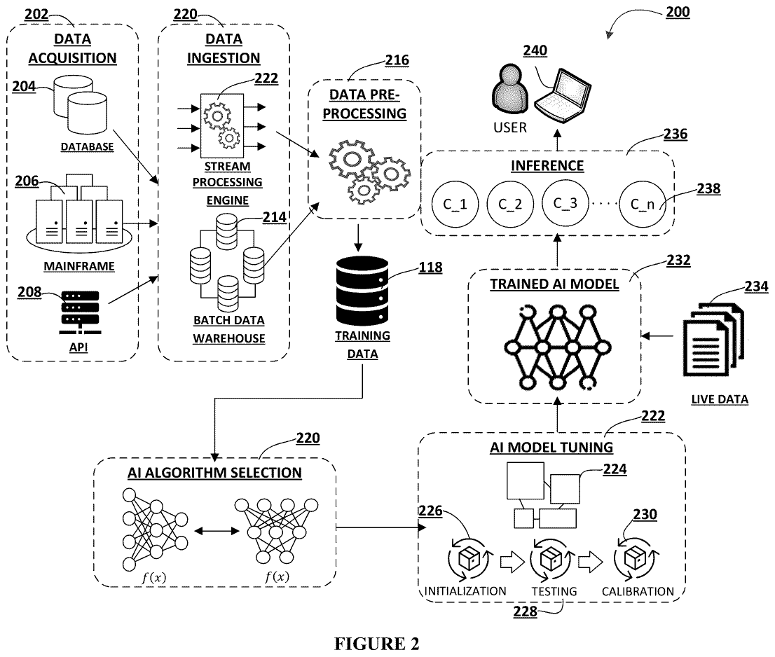

FIG. 2 illustrates an exemplary artificial intelligence (AI) engine subsystem architecture 200, in accordance with an embodiment of the disclosure. The artificial intelligence subsystem 200 may include a data acquisition engine 202, data ingestion engine 210, data pre-processing engine 216, AI engine tuning engine 222, and inference engine 236.

The data acquisition engine 202 may identify various internal and/or external data sources to generate, test, and/or integrate new features for training the artificial intelligence engine 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In artificial intelligence, the quality of data and the useful information that can be derived therefrom directly affects the ability of the artificial intelligence engine 224 to learn. The data pre-processing engine 216 may implement advanced integration and processing steps needed to prepare the data for artificial intelligence execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and /r combine variables into features, effectively reducing the amount of data that must be processed, while still accurately and completely describing the original data set. Depending on the type of artificial intelligence algorithm being used, this training data 218 may require further enrichment. For example, in supervised learning, the training data is enriched using one or more meaningful and informative labels to provide context so a artificial intelligence engine can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The AI tuning engine 222 may be used to train an artificial intelligence engine 224 using the training data 218 to make predictions or decisions without explicitly being programmed to do so. The artificial intelligence engine 224 represents what was learned by the selected artificial intelligence algorithm 220 and represents the rules, numbers, and any other algorithm-specific data structures required for classification. Selecting the right artificial intelligence algorithm may depend on a number of different factors, such as the problem statement and the kind of output needed, type and size of the data, the available computational time, number of features and observations in the data, and/or the like. Artificial intelligence algorithms may refer to programs (math and logic) that are configured to self-adjust and perform better as they are exposed to more data. To this extent, artificial intelligence algorithms are capable of adjusting their own parameters, given feedback on previous performance in making prediction about a dataset.

The artificial intelligence algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable artificial intelligence engine type. Each of these types of artificial intelligence algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the artificial intelligence engine, the AI tuning engine 222 may repeatedly execute cycles of experimentation 226, testing 228, and tuning 230 to optimize the performance of the artificial intelligence algorithm 220 and refine the results in preparation for deployment of those results for consumption or decision making. To this end, the AI tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the engine is the measurement used to determine which set of hyperparameters is best at identifying relationships and patterns between variables in a dataset based on the input, or training data 218. A fully trained artificial intelligence engine 232 is one whose hyperparameters are tuned and engine accuracy maximized.

The trained artificial intelligence engine 232, similar to any other software application output, can be persisted to storage, file, memory, or application, or looped back into the processing component to be reprocessed. More often, the trained artificial intelligence engine 232 is deployed into an existing production environment to make practical business decisions based on live data 234. To this end, the artificial intelligence subsystem 200 uses the inference engine 236 to make such decisions. The type of decision-making may depend upon the type of artificial intelligence algorithm used. For example, artificial intelligence engines trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, artificial intelligence engines trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, artificial intelligence engines that perform regression techniques may use live data 234 to predict or forecast continuous outcomes.

It will be understood that the embodiment of the artificial intelligence subsystem 200 illustrated in FIG. 2 is exemplary and that other embodiments may vary. As another example, in some embodiments, the artificial intelligence subsystem 200 may include more, fewer, or different components.

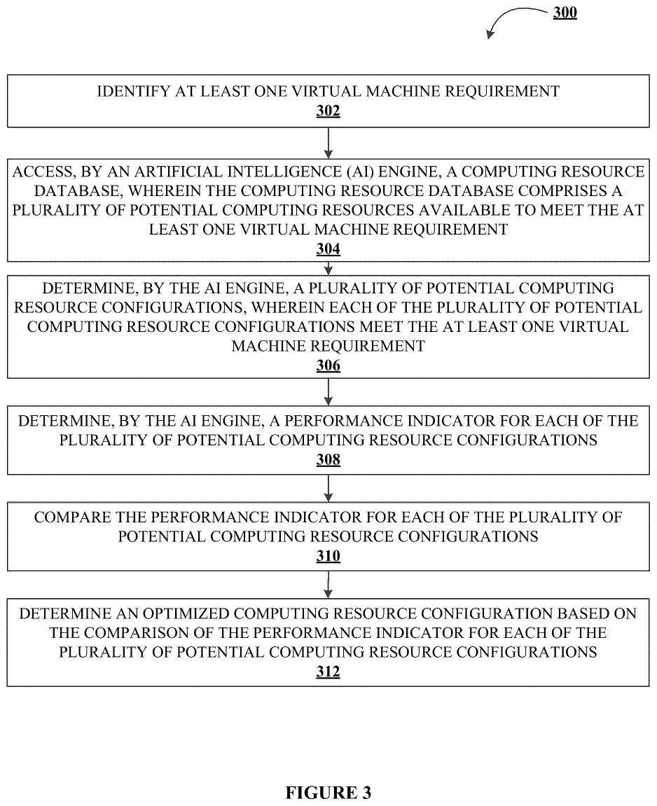

FIG. 3 illustrates a process flow 300 for automatically identifying optimal virtual machine component parameters, in accordance with an embodiment of the disclosure. In some embodiments, a system (e.g., similar to one or more of the systems described herein with respect to FIGS. 1A-1C) may perform one or more of the steps of process flow 300. For example, a system (e.g., the system 130 described herein with respect to FIG. 1A-1C) may perform the steps of process 300. In some embodiments, an artificial intelligence engine (e.g., such as the AI engine shown in FIG. 2) may perform some or all of the steps described in process flow 300.

As shown in block 302, the process flow 300 may include the step of identifying at least one virtual machine requirement. For instance, the virtual machine requirement may comprise a performance requirement, task requirement, system requirement, and/or the like for at least one virtual machine. For instance, such a virtual machine requirement may comprise a performance requirement such as but not limited to the virtual machine performing a task within a defined amount of time, using a defined maximum number of resources, and/or the like. Similarly, and in some embodiments, the virtual machine requirement may comprise task requirement such as, but not limited to, the virtual machine being capable of performing a defined task such as building and deploying an application, trying a new operating system (OS), spinning up a new environment for development and testing for developers, and/or the like. Additionally, and in some embodiments, the virtual machine requirement may comprise a system requirement such as a defied operating system that will need to be run in the virtual machine and making sure the virtual machine can run the operating system. As understood by a person of skill in the art, the virtual machine requirements listed are not intended to be limiting in any way, and any other virtual machine requirements now known or later developed are incorporated herein and can be used for completing the processes described herein.

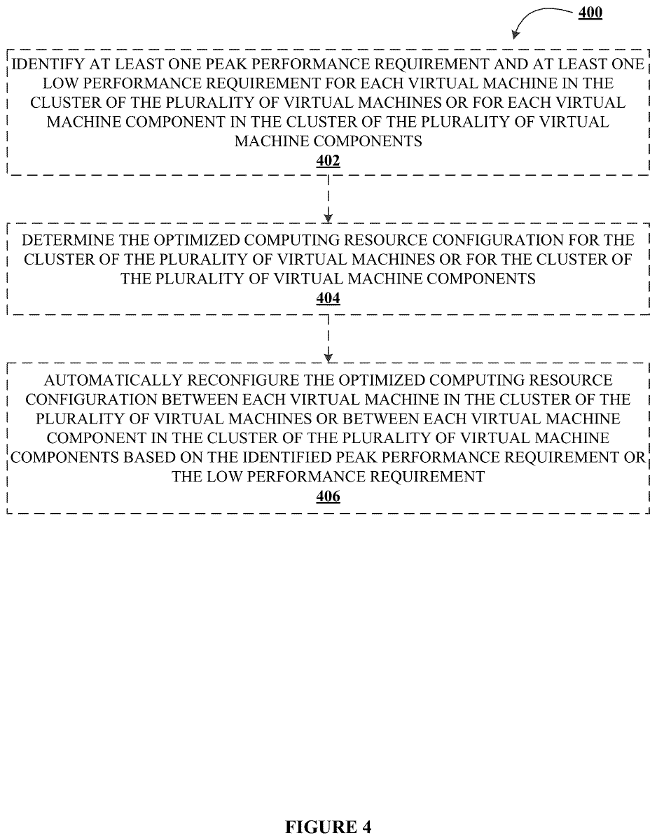

In some embodiments, the at least one virtual machine requirement comprises a plurality of virtual machine requirements across a cluster of a plurality of virtual machines or a cluster of a plurality of virtual machine components. For instance, the system may determine a cluster of virtual machines (multiple virtual machines) that can be improved based on the virtual machine requirement(s) or a cluster of virtual machine components (e.g., multiple applications, virtual devices, and/or the like) that can be improved based on the virtual machine requirement(s). As used herein, the cluster of the virtual machines and/or cluster of virtual machine components may refer to virtual machines and/or components that can share computing resources to improve their functionality, processing speed, processing capacity, central processing unit (CPU) usage, and/or the like. In this manner, the system may be configured to determine peaks and lows of usage across the computing resource configurations and their computing resources for each virtual machine and/or virtual machine component to determine which computing resource components can be shared between virtual machines or virtual machine components to help handle the functions/tasks of each virtual machine. For example, through shared resources at particular times where at least one virtual machine or one virtual machine component is at a low performance requirement and where at least one virtual machine or one virtual machine component is at a high/peak performance requirement. Such an embodiment is shown and described in more detail below with respect to FIG. 4.

Additionally, and in some embodiments, the virtual machine requirements may be identified by the system by the system receiving the virtual machine requirement from a user device associated with the system (e.g., a user device associated with an entity or user that is using the system to build a virtual machine), whereby the system may receive an indication or message from the user device indicating the virtual machine requirement(s). In some embodiments, the system may identify the virtual machine requirement(s) based on parsing and extracting data from a natural language message from the user, whereby the system may apply a natural language processor to determine the virtual machine requirement(s) of the user's message(s) to the system. In some embodiments, the system may comprise a database of tasks that need to be completed, such as a database comprising all the virtual machines that need to be generated and configured to perform tasks that are necessary to complete different requirements/functions within a network (e.g., the system may determine which tasks have not been completed and/or where virtual machines may be used to improve processes within the network in an automated manner). In such a manner, the system may determine where certain functions can be improved via a virtual machine(s) or via a new configuration of a pre-existing virtual machine.

In some embodiments, the virtual machine requirement comprises a cost constraint, and wherein the cost constraint is used by the AI engine to determine the plurality of potential computing resource configurations. For example, the system may identify a cost constraint, which may be in the same manner as how the system identifies the virtual machine requirement, which may be used by the system to determine the potential computing resource configurations to analyze for the virtual machine(s). In this manner, the cost constraint may be used as a maximum cost for each potential computing resource configuration determined and analyzed by the system, which may allow for the system to limit its potential computing resource configurations to determine and analyze, and thus improve the processing speed of this system to identify the optimized computing resource configuration (by not requiring the system to generate every single potential computing resource configuration including the potential computing resource configurations that are way above a normal budget or cost constraint). Thus, and as used herein, the cost constraint may be used by the system to determine which potential computing resource configurations that meet or are less than the cost constraint.

As shown in block 304, the process flow 300 may include the step of accessing, by an artificial intelligence (AI) engine, a computing resource database, wherein the computing resource database comprises a plurality of potential computing resources available to meet the at least one virtual machine requirement. For instance, the system may access—using a trained AI engine—a computing resource database, whereby the computing resource database may comprise a listing of all the computing resources available for use in the potential computing resource configurations used to complete/meet the virtual machine requirement(s). In some embodiments, the computing resource database may comprise a table, a list, and/or the like of all the potential computing resources that can be used in the virtual machine, such as those computing resources that are within the network associated with the virtual machine already (e.g., have previously been used for other virtual machines, and/or are stored in the network and not currently in use), can be implemented in the network (e.g., are available for purchase and can be implemented in the network after purchase), and/or the like. In this manner, and in some such embodiment, the computing resource database may comprise all the potential computing resources that can be used within a virtual machine to meet the virtual machine requirement.

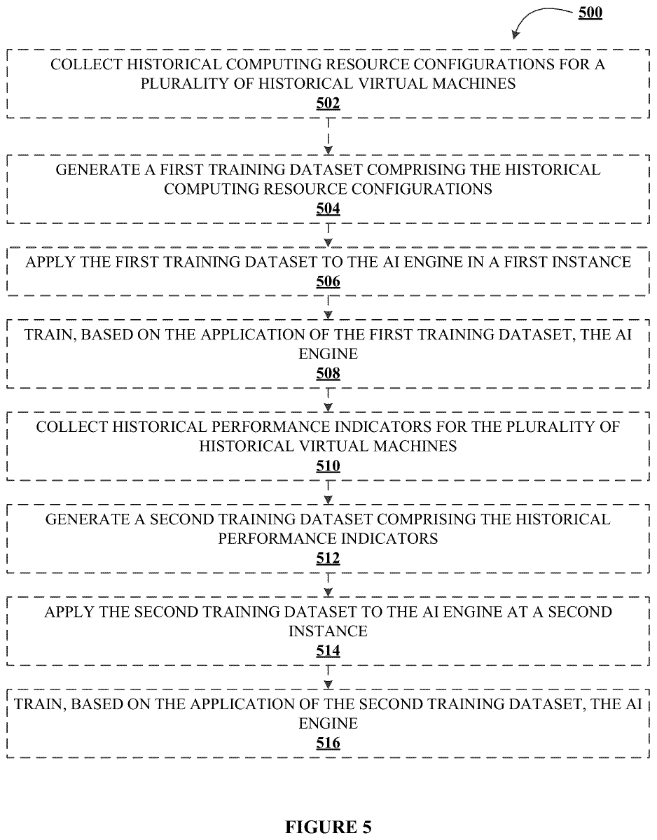

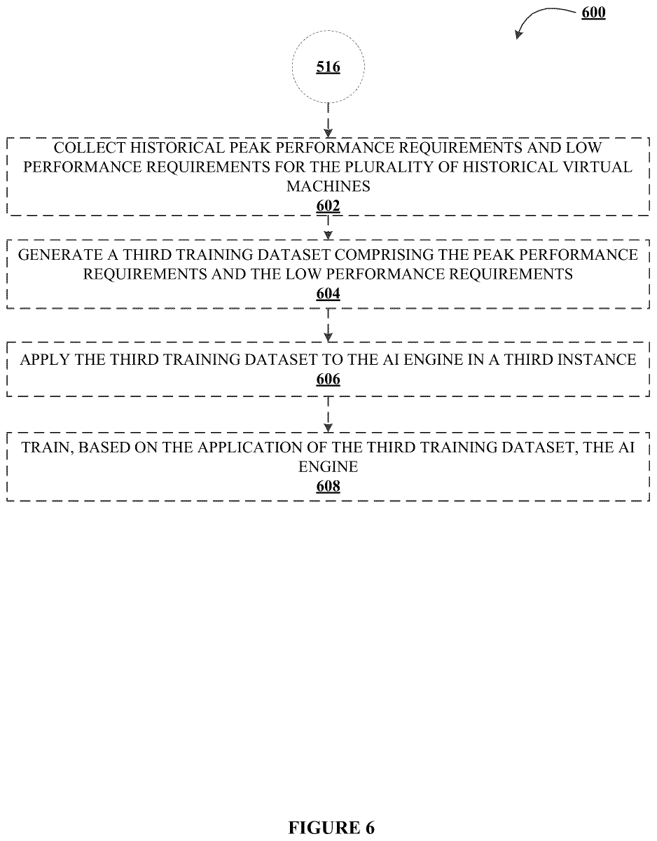

Additionally, and in some embodiments, the AI engine described herein may be pre-trained on the computing resource database, and in some instances, continually trained on the computing resource database as the computing resource database is updated with current computing resource components in the network and/or potential computing resource components that can be implemented in the network. Additionally, and in some embodiments, the AI engine may be pre-trained on historical data associated with historical virtual machines, associated historical virtual machine requirements, and/or the like. Such an embodiment is described in further detail below with respect to FIGS. 5 and 6.

As shown in block 306, the process flow 300 may include the step of determining, by the AI engine, a plurality of potential computing resource configurations, wherein each of the plurality of potential computing resource configurations meet the at least one virtual machine requirement. For instance, the system—using the trained AI engine—may determine the plurality of potential computing resource configurations to choose from in determining the optimized computing resource configuration for the virtual machine to complete the virtual machine requirement(s). As used herein, the potential computing resource configurations may comprise a plurality of different configurations of central processing unit (CPU) parameters (e.g., processor speed, cache size, number of cores), memory parameters (e.g., short-term memory capacity), disk parameters (e.g., disk capacity), storage parameters (e.g., permanent storage capacity), network interface parameters (e.g., network interface settings to optimize network performance), and/or the like. Thus, each potential computing resource configuration may comprise at least one different computing resource parameter from the other potential computing resource configurations determined by the AI engine. Thus, and in some such embodiments, the AI engine may generate each of the different potential computing resource configurations, and test each potential computing resource configurations for comparison and determination of the optimized computing resource configuration.

In some embodiments, the system—using the AI engine—may use the plurality of potential computing resources in the computing resource database to generate/determine each of the different potential computing resource configurations. Further, and in some embodiments, the system may use the cost constraint mentioned above to generate/determine the different potential computing resource configurations that are less than or meet the cost constraint. Additionally, and in some such embodiments, the system may take into account the upfront cost of implementing each potential computing resource configuration and the operating cost for each potential computing resource configuration in making the determination if the cost of each potential computing resource configuration is less than or equal to the cost constraint.

Additionally, and in some embodiments, before the AI engine continues with its analysis of each of the potential computing resource configurations to determine the optimized computing resource configuration, the AI engine may determine which of the potential computing resource components can complete the virtual resource requirement(s), and only those potential computing resource components that can complete the virtual resource requirement(s) will the AI engine analyze in the next steps of the process flow 300. Thus, and in some such embodiments, the virtual machine requirement(s) may be used by the AI engine as an absolute prerequisite for each potential computing resource configuration before the AI engine can determine any performance indicators for the potential computing resource configurations, and thus determine the optimized computing resource configuration.

As shown in block 308, the process flow 300 may include the step of determining, by the AI engine, a performance indicator for each of the plurality of potential computing resource configurations. For example, the system may determine a performance indicator for each of potential computing resource configuration determined in block 306. Such a performance indicator may comprise a cost indicator for the potential computing resource configuration to complete the virtual machine requirement(s), a completion time for the potential computing resource configuration to complete the virtual machine requirement(s), a latency between a user of the virtual machine's action and the virtual machine response for the potential computing resource configuration, a CPU usage for the virtual machine comprising the potential computing resource configuration, an error rate of the virtual machine comprising the potential computing resource configuration, and/or the like. Thus, and in some embodiments, the system may identify the performance indicator type that a user of the virtual machine is most concerned with (e.g., the cost, the completion time, the latency, the CPU usage, the error rate, and/or the like), and the system may base its determination of the optimized computing resource configuration based on this performance indicator type.

In some embodiments, the AI engine may be trained to determine the performance indicator for each potential computing resource configuration based on historical potential computing resource configurations and their performance indicators. In some embodiments, the AI engine may determine the performance indicator for each potential computing resource configuration by deploying the potential computing resource configuration in a simulated virtual machine and/or within the actual virtual machine, and logging the output and performance metrics of the potential computing resource configuration in the simulated virtual machine or real virtual machine. In some embodiments, such a deployment of the potential computing resource configuration may comprise a deployment within a container, which may be used by the system to isolate the potential computing resource configuration for testing to determine its performance metrics and determine the performance indicator and which may—in some embodiments—comprise the virtual machine or simulated virtual machine.

In some embodiments, and upon deploying the potential computing resource configuration and determining the performance indicator, the system may automatically and in real time or near real time to determining the performance indicator, delete the potential computing resource configuration from the virtual machine, simulated virtual machine, and/or container. Thus, and by deleting each potential computing resource configuration after determining each performance indicator, and loading the next potential computing resource configuration to determine its performance indicator, the system may conserve computing resources in its analysis by only using one virtual machine, one simulated virtual machine, and/or one container.

In some embodiments, the performance indicator for each of the plurality of potential computing resource configurations is associated with a gradient descent. For example, and in some embodiments, a gradient descent may show the peaks and lows of the performance indicator, such that the AI engine may determine the lowest performance indicator of all the performance indicators as the potential computing resource configuration that is most optimal. For instance, and by showing the performance indicators in a graphical format, the system may determine which performance indicator (and its associated potential computing resource configuration) is lowest compared to the other performance indicators of the same type. Thus, and by way of non-limiting example, where the performance indicator type is the cost for the virtual machine with the potential computing resource configuration, the system may identify the potential computing resource configuration with the lowest upfront and/or operating cost to complete/meet the virtual machine requirement(s), and thus may determine the optimized computing resource configuration is the potential computing resource configuration with the lowest cost. There, and in some embodiments, the performance indicator for each of the plurality of potential computing resource configurations comprises a cost indicator for employing each potential computing resource configuration. In other words, and by showing the performance indicators as a gradient descent, the system may determine the optimized computing resource configuration is the potential computing resource configuration with the global minima of the plurality of performance indicators.

Additionally, and/or alternatively, the performance indicator is based on a processing speed of each potential computing resource configuration, a lowest parameter combination of computing resources, or a new resource utilization combination. For instance, and in such embodiments, the performance indicator type may comprise processing speed for the virtual machine and/or completion time for the virtual machine to complete/meet the virtual machine requirement, the lowest parameter combination of the potential computing resource configuration (e.g., the lowest combined CPU parameter value, memory parameter value, storage parameter, disk parameter, and/or the like), the lowest new resource utilization combination (e.g., the lowest number of new computing resources that need to be implemented in the network, and thus, the least upfront cost in some instances as the potential computing resource configuration may only comprise computing resources already implemented in the network). In such embodiments, the system may likewise organize these performance indicators of the same performance indicator type in a gradient descent and/or graphical format to determine the lowest performance indicator and the associated potential computing resource configuration.

As shown in block 310, the process flow 300 may include the step of comparing the performance indicator for each of the plurality of potential computing resource configurations. For instance, the system may compare the performance indicators of the same performance indicator type to determine the global minima of the performance indicators, and thus, determine the optimized computing resource configuration from the associated potential computing resource configuration. In some embodiments, and where the performance indicator type comprises an indicator that the optimized performance indicator is the global maxima, then the system may determine the optimized computing resource configuration is the potential computing resource configuration with the highest performance indicator.

Additionally, and as used herein, the comparison of the performance indicators comprises a determination of the differences between the performance indicators for each potential computing resource configuration. Such a difference may comprise a value of the performance indicator (e.g., value of the cost for each potential computing resource configuration) and determining the global minima and/or the global maxima of all the performance indicators.

As shown in block 312, the process flow 300 may include the step of determining an optimized computing resource configuration based on the comparison of the performance indicator for each of the plurality of potential computing resource configurations. For example, the system may determine the optimized computing resource configuration as the potential computing resource configuration with the performance indicator that is the global minima (or in some embodiments, the global maxima) of all the performance indicators. Thus, and upon identifying the optimized computing resource configuration, the system may automatically configure the virtual machine with the optimized computing resource configuration (i.e., with the CPU identified in the optimized computing resource configuration, the memory identified in the optimized computing resource configuration, the disk identified in the optimized computing resource configuration, the network interface identified in the optimized computing resource configuration, and/or the like). Such a configuration may be automatically integrated into the virtual machine in real time or near real time to system determining the optimized computing resource configuration.

Additionally, and in some embodiments, the processes described herein in regard to blocks 310-312, may be carried out by the trained AI engine discussed hereinabove. In some embodiments, and upon the system configuring the virtual machine with the optimized computing resource configuration, the system may additionally collect the real performance metrics of the virtual machine as the virtual machine functions and performs its task(s)/function(s), and may continually train and update the AI engine with updated performance metrics and cost metrics.

In some embodiments, and through the use of this continual training of the AI engine with current data of the virtual machine using the optimized computing resource configuration, the system may determine the highs or peaks of performance levels for the virtual machine and/or low performance levels for the virtual machine and the expected times the virtual machine will go through these peaks and lows. Such peaks and lows may be used by the system—using the AI engine—to reconfigure the computing resources in the virtual machine as needs change, and as other virtual machines go through similar peaks and lows and may need additional computing resources at particular times. Such an embodiment is described in further detail below with respect to FIG. 4.

FIG. 4 illustrates a process flow 400 for automatically reconfiguring the optimized computing resource configuration within a cluster of virtual machines and/or cluster of virtual machine components based on performance requirements, in accordance with an embodiment of the disclosure. In some embodiments, a system (e.g., similar to one or more of the systems described herein with respect to FIGS. 1A-1C) may perform one or more of the steps of process flow 400. For example, a system (e.g., the system 130 described herein with respect to FIG. 1A-1C) may perform the steps of process 400. In some embodiments, an artificial intelligence engine (e.g., such as the AI engine shown in FIG. 2) may perform some or all of the steps described in process flow 400.

In some embodiments, and as shown in block 402, the process flow 400 may include the step of identifying at least one peak performance requirement and at least one low performance requirement for each virtual machine in the cluster of the plurality of virtual machines or for each virtual machine component in the cluster of the plurality of virtual machine components. For example, the system may identify at least one peak performance requirement (i.e., when the virtual machine is performing at peak performance capacity, which may be indicated by its high computing resources consumption of energy, slower processing speeds, and/or the like). Thus, and when a virtual machine is operating at its peak performance or highest performance, the virtual machine may need extra computing resources to avoid interruption to its functions, avoid slower processing speeds and completion times, and/or the like. Additionally, and/or alternatively, the system may identify when the virtual machine undergoes low performance requirements (i.e., when the virtual machine is performing at a low performance capacity, which may be indicated by its low computing resources consumption of energy, high processing speeds, and/or the like). For instance, and where the functions of the virtual machine are not too much for the virtual machine to function normally and at normal processing speeds and/or without expending too much energy, then the virtual machine may comprise a low performance requirement.

Thus, and as the virtual machine functions over time with the optimized computing resource configuration of FIG. 3, the system may continually analyze the performance of the virtual machine and determine when the virtual machine needs extra computing resources (such as from a virtual machine that is undergoing a low performance requirement at the time the current virtual machine is undergoing a high performance requirement). Thus, and as the virtual machines are functioning, and in an instance where virtual machine A—for example—is undergoing a high performance requirement, the system may determine that virtual machine B is undergoing a low performance requirement at the same time, and may reconfigure the optimized computing resource configuration for both virtual machine A and virtual machine B to share computing resources to help virtual machine A complete its function. In such an embodiment, the identification of these virtual machines that may share computing resources may be referred to as a cluster of virtual machines. In some embodiments, a cluster of virtual machine components may be used in the same or similar manner as the cluster of virtual machines, except the virtual machine components may comprise specified applications, components, and/or the like that require similar components from low performing virtual machines to function.

In some embodiments, and as shown in block 404, the process flow 400 may include the step of determining the optimized computing resource configuration for the cluster of the plurality of virtual machines or for the cluster of the plurality of virtual machine components. For example, the system may determine the optimized computing resource configuration for each virtual machine and/or for each virtual machine component within a cluster, such that the system can determine when the computing resources between each virtual machine and/or between each virtual machine component to operate optimally. Thus, and in some embodiments, the optimized computing resource configuration for the cluster may automatically and dynamically change based on the expected time of future peak performance requirements and/or future low performance requirements. Additionally, and in some embodiments, the optimized computing resource configuration for the cluster may automatically and dynamically change based on the currently identified peak performance requirements and/or current low performance requirements for each virtual machine or virtual machine component in the cluster. In other words, the system may actively and proactively reconfigure the computing resources between the virtual machines and/or virtual machine components such that some or all of the computing resources can be shared between the virtual machines and/or virtual machine components without causing interruptions or slow processing speeds to any of the virtual machines or virtual machine components in the cluster.

For instance, and where virtual machine A has a peak performance requirement because its memory capacity is currently at its peak capacity, and the system determines virtual machine B has a low performance requirement and its memory capacity is at a low capacity, then the system may automatically determine the optimized computing resource configuration between virtual machine A and B comprises virtual machine B sharing its memory with virtual machine A. Such a sharing of the computing resources in the cluster of virtual machines or virtual machine components may occur at pre-defined times (such as expected peak performance requirements and expected low performance requirements), and/or at a current time after the system has determined—in real time or near real time—that a virtual machine in the cluster cannot complete its function or task in an optimal manner and/or at all.

In some embodiments, and as shown in block 406, the process flow 400 may include the step of automatically reconfiguring the optimized computing resource configuration between each virtual machine in the cluster of the plurality of virtual machines or between each virtual machine component in the cluster of the plurality of virtual machine components based on the identified peak performance requirement or the low performance requirement. For example, the system may automatically and dynamically reconfigure the optimized computing resource configuration for the virtual machines and/or virtual machine components in the cluster when necessary to handle the peak performance requirement of a virtual machine and/or virtual machine component.

In some embodiments, the system may be configured to evenly split the burden of the shared computing resources between a plurality of virtual machines operating at a low performance requirements. In such a manner, no virtual machine or virtual machine component is overloaded when it helps the virtual machine associated with the peak performance requirement, which may thus conserve computing resources between a plurality of virtual machines. Additionally, and/or alternatively, the system may be configured to identify the virtual machine that comprises the computing resource(s) capable of helping with the overloaded computing resource(s) by identifying the virtual machine with the lowest performance requirement. In this manner, only one virtual machine is used to help the peak performing virtual machine, and other virtual machines are conserved for other potential peak performing virtual machines. Such an embodiment may conserve network resources by allowing only one computing resource to be shared with the peak performing virtual machine.

FIG. 5 illustrates a process flow 500 for training the AI engine in a first and second instance, in accordance with an embodiment of the disclosure. In some embodiments, a system (e.g., similar to one or more of the systems described herein with respect to FIGS. 1A-1C) may perform one or more of the steps of process flow 500. For example, a system (e.g., the system 130 described herein with respect to FIG. 1A-1C) may perform the steps of process 500. In some embodiments, an artificial intelligence engine (e.g., such as the AI engine shown in FIG. 2) may perform some or all of the steps described in process flow 500.

In some embodiments, and as shown in block 502, the process flow 500 may include the step of collecting historical computing resource configurations for a plurality of historical virtual machines. For instance, the system may collect historical computing resource configurations used in historical or past virtual machines from a historical database, an external source (external to the network), an internal source (internal to the network), and/or the like. In some embodiments, the historical computing resource configurations may comprise the CPU parameters, memory parameters, disk parameters, storage parameters, network interface parameters, and/or the like, used in each of the historical virtual machines. Additionally, and in some embodiments, the collection of the historical computing resource configurations may comprise an indication of whether the historical virtual machines were able to perform the historical virtual machine requirements and what the historical virtual machine requirements were.

In some embodiments, and as shown in block 504, the process flow 500 may include the step of generating a first training dataset comprising the historical computing resource configurations. For example, and in some embodiments, the system may generate at least a first training dataset comprising the historical computing resource configurations. In some embodiments, the first training dataset may further comprise the data of the historical virtual machines, such as but not limited to the historical virtual machine requirements and whether the historical virtual machines were able to meet their virtual machine requirements. In some embodiments, the system may generate a plurality of training datasets from the historical computing resource configurations, whereby the plurality of training datasets may each comprise a defined set or defined capacity of historical computing resource configurations (and in some embodiments, their associated historical virtual machine data).

In some embodiments, and as shown in block 506, the process flow 500 may include the step of applying the first training dataset to the AI engine in a first instance. For example, the system may apply the first training dataset (and/or a plurality of training datasets generated from the historical computing resource configurations) to the AI engine at least at a first instance. In some embodiments, the training datasets generated from the historical computing resource configurations may be applied to the AI engine systematically and continuously as each training dataset is generated and after the previous training dataset has been applied and analyzed by the AI engine.

In some embodiments, and as shown in block 508, the process flow 500 may include the step of training, based on the application of the first training dataset, the AI engine. For example, the system may train the AI engine by applying at least the first training dataset to the AI engine and triggering the AI engine to analyze the data within the first training dataset. Such an analysis by the AI engine may comprise the AI engine determining patterns, create predictions, and evaluate its accuracy based on its predictions as compared to the data within the first training dataset.

In some embodiments, and as shown in block 510, the process flow 500 may include the step of collecting historical performance indicators for the plurality of historical virtual machines. For instance, the system may additionally collect historical performance indicators for the plurality of historical virtual machines, whereby the historical performance indicators such as but not limited to cost indicators, processing speed indicators, completion time indicators, latency indicator, CPU usage indicator, error rate indicator, and/or the like, of the historical virtual machines. Such historical performance indicators may be collected from the same source(s) as those described above for collecting the historical computing resource configurations (e.g., internal source, external source, database, and/or the like).

Additionally, and as used herein, each of the historical data used to train the AI engine (e.g., the historical computing resource configurations, historical performance indicators, historical peak performance requirements, historical low performance requirements, and/or the like) may be collected after the historical virtual machines have been generated and run at least at a first instance, and/or continuously. Thus, and as each virtual machine associated with the system is run and, in some instances, updated, the system may collect the data associated with the virtual machines (e.g., the computing resource configurations, performance indicators, peak performance requirements, low performance requirements, and/or the like) and train the AI engine at either at first instance for the virtual machine or a continuous basis as the data is collected. Such data, after it is generated and collected from the virtual machines may be referred to as historical data.

In some embodiments, and as shown in block 512, the process flow 500 may include the step of generating a second training dataset comprising the historical performance indicators. For example, the system may generate at least a second training dataset comprising the historical performance indicators described above. Additionally, and in some embodiments, the system may generate a plurality of training datasets from the historical performance indicators in a similar manner to the plurality of training datasets from the historical computing resource configurations described above. Such training datasets may be applied to the AI engine as they are generated, in real time or near real time.

In some embodiments, and as shown in block 514, the process flow 500 may include the step of applying the second training dataset to the AI engine at a second instance. For instance, the system may apply at least the second training dataset to the AI engine in the same or similar manner as the application of the first training dataset described above. Such an application of at least the second training dataset may allow the AI engine to determine patterns regarding the historical computing resource configurations and their historical performance indicators.

In some embodiments, and as shown in block 516, the process flow 500 may include the step of training, based on the application of the second training dataset, the AI engine. For instance, the system may train the AI engine to generate future predictions regarding virtual machines, their potential computing resource configurations and their performance indicators. Thus, and based at least one this initial training, and any continuous training of the AI engine with both computing resource configurations and their associated performance indicators, the AI engine may be continuously trained and refined to make more accurate predictions on optimized computing resource configurations.

FIG. 6 illustrates a process flow 600 for training the AI engine in a third instance, in accordance with an embodiment of the disclosure. In some embodiments, a system (e.g., similar to one or more of the systems described herein with respect to FIGS. 1A-1C) may perform one or more of the steps of process flow 600. For example, a system (e.g., the system 130 described herein with respect to FIG. 1A-1C) may perform the steps of process 600. In some embodiments, an artificial intelligence engine (e.g., such as the AI engine shown in FIG. 2) may perform some or all of the steps described in process flow 600.

In some embodiments, and as shown in block 602, the process flow 600 may include the step of collecting historical peak performance requirements and low performance requirements for the plurality of historical virtual machines. For example, the system may collect historical peak performance requirements and/or historical low performance requirements for each of the historical virtual machines from the same source(s) described hereinabove and used to collect the historical computing resource configurations and/or historical performance indicators. In some embodiments, the historical peak performance requirements and/or historical low performance requirements may be collected directly from the historical virtual machines as the historical virtual machines perform their tasks and functions, such that the system collects the historical peak performance requirements and/or historical low performance requirements in real time as the virtual machines generate their outputs. Additionally, and in some embodiments, the process described herein with respect to FIG. 6 may follow the process described above with respect to FIG. 5.

In some embodiments, and as shown in block 604, the process flow 600 may include the step of generating a third training dataset comprising the peak performance requirements and the low performance requirements. For example, the system may collect the peak performance requirements and low performance requirements as the historical virtual machines run, determine the times of each peak performance requirements and the low performance requirements, and determine which computing resources of the historical virtual machines are operating at their maximum capacity or at their lowest capacity. Based on this collection, the system may generate at least the third training dataset comprising this peak performance and low performance data, the times of each peak and low performance, and their associated computing resources across the peak and low performance periods.

In some embodiments, and as shown in block 606, the process flow 600 may include the step of applying the third training dataset to the AI engine in a third instance. For example, and upon generating at least the third training dataset, the system may automatically apply the third training dataset to the AI engine to train the AI engine to predict future peak performance requirements and low performance requirements, their associated times, and the associated computing resources across the peak performance periods and low performance periods.

In some embodiments, and as shown in block 608, the process flow 600 may include the step of training, based on the application of the third training dataset, the AI engine. Thus, and upon applying at least the third training dataset, the AI engine may be trained to predict future peak performance requirements and low performance requirements for each future virtual machine, and how to reconfigure the optimized computing resource configurations to handle each of these performance requirements.

Additionally, and in some embodiments, the system may further collect feedback data from the user of the virtual machines, such as feedback data indicating whether a virtual machine is essential for the user and/or the network and thus, cannot ever share its computing resources. Such feedback may be used by the system to retrain the AI engine to reconfigure the shared computing resources between the virtual machines. Additionally, and in some embodiments, the feedback data may comprise data regarding the virtual machines and their current operating and performance metrics after the computing resources are shared, and such feedback data may be used to reconfigure the already reconfigured optimized computing resource configurations.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for automatically identifying optimal virtual machine component parameters, the system comprising:
a memory device with computer-readable program code stored thereon;
at least one processing device operatively coupled to the at least one memory device and the at least one communication device, wherein executing the computer-readable code is configured to cause the at least one processing device to:
identify at least one virtual machine requirement;
access, by an artificial intelligence (AI) engine, a computing resource database, wherein the computing resource database comprises a plurality of potential computing resources available to meet the at least one virtual machine requirement;
determine, by the AI engine, a plurality of potential computing resource configurations, wherein each of the plurality of potential computing resource configurations meet the at least one virtual machine requirement;
determine, by the AI engine, a performance indicator for each of the plurality of potential computing resource configurations;
compare the performance indicator for each of the plurality of potential computing resource configurations; and
determine an optimized computing resource configuration based on the comparison of the performance indicator for each of the plurality of potential computing resource configurations.

2. The system of claim 1, wherein the at least one virtual machine requirement comprises a plurality of virtual machine requirements across a cluster of a plurality of virtual machines or a cluster of a plurality of virtual machine components.

3. The system of claim 2, wherein executing the computer-readable code is further configured to cause the at least one processing device to:
identify at least one peak performance requirement and at least one low performance requirement for each virtual machine in the cluster of the plurality of virtual machines or for each virtual machine component in the cluster of the plurality of virtual machine components;
determine the optimized computing resource configuration for the cluster of the plurality of virtual machines or for the cluster of the plurality of virtual machine components; and
automatically reconfigure the optimized computing resource configuration between each virtual machine in the cluster of the plurality of virtual machines or between each virtual machine component in the cluster of the plurality of virtual machine components based on the identified peak performance requirement or the low performance requirement.

4. The system of claim 1, wherein the plurality of potential computing resource configurations comprises a plurality of different configurations of central processing unit (CPU) parameters, memory parameters, disk parameters, storage parameters, and network interface parameters.

5. The system of claim 1, wherein executing the computer-readable code is further configured to cause the at least one processing device to:
collect historical computing resource configurations for a plurality of historical virtual machines;
generate a first training dataset comprising the historical computing resource configurations;
apply the first training dataset to the AI engine in a first instance;
train, based on the application of the first training dataset, the AI engine;
collect historical performance indicators for the plurality of historical virtual machines;
generate a second training dataset comprising the historical performance indicators;
apply the second training dataset to the AI engine at a second instance; and
train, based on the application of the second training dataset, the AI engine.

6. The system of claim 5, wherein executing the computer-readable code is further configured to cause the at least one processing device to:
collect historical peak performance requirements and low performance requirements for the plurality of historical virtual machines;
generate a third training dataset comprising the peak performance requirements and the low performance requirements;
apply the third training dataset to the AI engine in a third instance; and
train, based on the application of the third training dataset, the AI engine.

7. The system of claim 1, wherein the performance indicator for each of the plurality of potential computing resource configurations is associated with a gradient descent.

8. The system of claim 1, wherein the performance indicator for each of the plurality of potential computing resource configurations comprises a cost indicator for employing each potential computing resource configuration.

9. The system of claim 1, wherein the virtual machine requirement comprises a cost constraint, and wherein the cost constraint is used by the AI engine to determine the plurality of potential computing resource configurations.

10. The system of claim 1, wherein the performance indicator is based on a processing speed of each potential computing resource configuration, a lowest parameter combination of computing resources, or a new resource utilization combination.

11. A computer program product for automatically identifying optimal virtual machine component parameters, wherein the computer program product comprises at least one non-transitory computer-readable medium having computer-readable program code portions embodied therein, the computer-readable program code portions which when executed by a processing device are configured to cause the processor to:
identify at least one virtual machine requirement;
access, by an artificial intelligence (AI) engine, a computing resource database, wherein the computing resource database comprises a plurality of potential computing resources available to meet the at least one virtual machine requirement;
determine, by the AI engine, a plurality of potential computing resource configurations, wherein each of the plurality of potential computing resource configurations meet the at least one virtual machine requirement;
determine, by the AI engine, a performance indicator for each of the plurality of potential computing resource configurations;
compare the performance indicator for each of the plurality of potential computing resource configurations; and
determine an optimized computing resource configuration based on the comparison of the performance indicator for each of the plurality of potential computing resource configurations.

12. The computer program product of claim 11, wherein the at least one virtual machine requirement comprises a plurality of virtual machine requirements across a cluster of a plurality of virtual machines or a cluster of a plurality of virtual machine components.

13. The computer program product of claim 12, wherein the computer-readable program code portions which when executed by the processing device are further configured to cause the processor to:
identify at least one peak performance requirement and at least one low performance requirement for each virtual machine in the cluster of the plurality of virtual machines or for each virtual machine component in the cluster of the plurality of virtual machine components;
determine the optimized computing resource configuration for the cluster of the plurality of virtual machines or for the cluster of the plurality of virtual machine components; and
automatically reconfigure the optimized computing resource configuration between each virtual machine in the cluster of the plurality of virtual machines or between each virtual machine component in the cluster of the plurality of virtual machine components based on the identified peak performance requirement or the low performance requirement.

14. The computer program product of claim 11, wherein the plurality of potential computing resource configurations comprises a plurality of different configurations of central processing unit (CPU) parameters, memory parameters, disk parameters, storage parameters, and network interface parameters.

15. The computer program product of claim 11, wherein the performance indicator for each of the plurality of potential computing resource configurations comprises a cost indicator for employing each potential computing resource configuration.

16. A computer implemented method for automatically identifying optimal virtual machine component parameters, the computer implemented method comprising:
identifying at least one virtual machine requirement;
accessing, by an artificial intelligence (AI) engine, a computing resource database, wherein the computing resource database comprises a plurality of potential computing resources available to meet the at least one virtual machine requirement;
determining, by the AI engine, a plurality of potential computing resource configurations, wherein each of the plurality of potential computing resource configurations meet the at least one virtual machine requirement;
determining, by the AI engine, a performance indicator for each of the plurality of potential computing resource configurations;
comparing the performance indicator for each of the plurality of potential computing resource configurations; and
determining an optimized computing resource configuration based on the comparison of the performance indicator for each of the plurality of potential computing resource configurations.

17. The computer implemented method of claim 16, wherein the at least one virtual machine requirement comprises a plurality of virtual machine requirements across a cluster of a plurality of virtual machines or a cluster of a plurality of virtual machine components.

18. The computer implemented method of claim 17, further comprising:
Identifying at least one peak performance requirement and at least one low performance requirement for each virtual machine in the cluster of the plurality of virtual machines or for each virtual machine component in the cluster of the plurality of virtual machine components;
determining the optimized computing resource configuration for the cluster of the plurality of virtual machines or for the cluster of the plurality of virtual machine components; and
automatically reconfiguring the optimized computing resource configuration between each virtual machine in the cluster of the plurality of virtual machines or between each virtual machine component in the cluster of the plurality of virtual machine components based on the identified peak performance requirement or the low performance requirement.

19. The computer implemented method of claim 16, wherein the plurality of potential computing resource configurations comprises a plurality of different configurations of central processing unit (CPU) parameters, memory parameters, disk parameters, storage parameters, and network interface parameters.

20. The computer implemented method of claim 16, wherein the performance indicator for each of the plurality of potential computing resource configurations comprises a cost indicator for employing each potential computing resource configuration.
